(19) United States
(12) Patent Application Publication
(10) Pub. No.: US 2008/0056491 A1
(43) Pub. Date: Mar. 6, 2008

(54) Methods and Systems For Managing Digital Sheet Music on a Digital Sheet Music Display System

(75) Inventors: Tim Craig, Georgetown, KY (US); Michael Craig, Frankfort, KY (US); Mark Craig, Georgetown, KY (US); Daniel Maggart, Georgetown, KY (US); Doug Anderson, Frankfort, KY (US)

Correspondence Address: DINSMORE & SHOHL, LLP, 1900 CHEMED CENTER, 255 EAST FIFTH STREET, CINCINNATI, OH, 45202, US

(73) Assignee: COREVALUS SYSTEMS, LLC, Georgetown, KY (US)

(21) Appl. No.: 11/848,880

(22) Filed: Aug. 31, 2007

Related U.S. Application Data
(60) Provisional application No. 60/824,154, filed on Aug. 31, 2006.
(60) Provisional application No. 60/824,172, filed on Aug. 31, 2006.
(60) Provisional application No. 60/824,180, filed on Aug. 31, 2006.
(60) Provisional application No. 60/824,193, filed on Aug. 31, 2006.
(60) Provisional application No. 60/824,190, filed on Aug. 31, 2006.

(51) Int. Cl. H04L 9/00; G06F 3/048; G06F 7/10

(52) U.S. Cl. 380/44; 707/5; 715/810; 707/E17.017

(57) ABSTRACT

Method for transmitting digital sheet music from a music database to a local music management system. Establishing a connection between the music database and the local music management system. Digital sheet music data files are sent from the music database to the local music management system. Methods of encrypting digital sheet music data files.

### CROSS REFERENCE TO RELATED APPLICATIONS

This application claims priority from U.S. Provisional Patent Application Ser. No. 60/824,154 filed Aug. 31, 2006; U.S. Provisional Patent Application Ser. No. 60/824,172 filed Aug. 31, 2006; U.S. Provisional Patent Application Ser. No. 60/824,180 filed Aug. 31, 2006; U.S. Provisional Patent Application Ser. No. 60/824,193 filed Aug. 31, 2006; and U.S. Provisional Patent Application Ser. No. 60/824,190 filed Aug. 31, 2006. The entire disclosure of which are hereby incorporated by reference herein.

### TECHNICAL FIELD

The present application relates to methods and systems for managing digital sheet music, and more particularly, to methods, apparatus and systems for obtaining, managing, creating, and editing digital sheet music for utilization by an electronic sheet music management system.

### BACKGROUND

In a conventional church or school music team environment, the team may have hundreds of songs available to select for a particular performance and/or rehearsal. Each of these songs is typically in sheet music and stored in cabinets, folders or files to preserve some order and preservation of the sheet music itself. In planning a performance or rehearsal, the director or team of musicians or singers will select several works of music and then retrieve the corresponding sheet music from a sheet music filing or storage system. Sometimes during a performance or rehearsal, it is desirable to change one or more of the songs. However, due to the difficulty of having to retrieve the actual sheet music for another song on an available song list, it is very difficult or even impossible to play a song that was not originally selected as the order of songs for that service due to the fact that music may not be distributed to each of the music team members. Even changing the order of the music can also be difficult since the musicians are typically using their hands for their instrument which limits their ability to swap the order of music on their stand. While in some environments there are breaks between songs, which allow the musician to reorder his music, however, sometimes in a performance environment, there are smooth transitions between each song as such there is continuous music being played which minimizes the ability of the musician to change sheet music order.

These and other items factor in the difficulty in a music team environment for dynamically switching the order of songs to be performed during a service or selecting and deleting songs from the musical performance. As such, there is a need for new methods and systems for managing sheet music. Accordingly, improved methods and systems for managing digital sheet music are desired.

### SUMMARY

The present application relates to new and improved methods, apparatus and systems for displaying electronic digital sheet music on multiple computer displays for a team of musicians or singers to use. One aspect of the present invention is a method for transmitting digital sheet music from a music database to a local music management system. The method comprises establishing a connection between the music database and the local music management system. A retrieval code is sent for a desired digital sheet music to the music database, wherein the retrieval code includes the information corresponding to the desired digital sheet music title. A digital sheet music data file is received from the music database in response to the retrieval code. The digital sheet music data file is stored in a storage medium, wherein the storage medium is in electronic communication with the local music management system.

These methods and systems of the present application are advantageous for obtaining and managing digital sheet music on a digital sheet music display system. Additional advantages will be apparent in view of the detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic illustration of an exemplary music display system according to the first embodiment of the present invention;

FIG. 2 is a schematic illustration of an exemplary music management system according to a second embodiment of the present invention;

FIG. 3 is a schematic illustration of an exemplary graphical user interface according to a third embodiment of the present invention;

FIG. 4 is a schematic illustration of an exemplary graphical user interface according to the fourth embodiment of the present invention;

FIG. 5 is a schematic illustration of an exemplary graphical user interface according to the fifth embodiment of the present invention;

FIG. 6 is a schematic illustration of an exemplary graphical user interface according to the sixth embodiment of the present invention;

FIG. 7 is a schematic illustration of an exemplary graphical user interface according to the seventh embodiment of the present invention;

FIG. 8 is a schematic illustration of an exemplary graphical user interface according to the eighth embodiment of the present invention; and

FIG. 9 is a schematic illustration of an exemplary graphical user interface according to the ninth embodiment of the present invention.

The embodiments set forth in the drawings are illustrative in nature, and not intended to be limiting of the invention defined by the claims. Moreover, the individual features of the drawings and the invention will be more fully apparent and understood in view of the detailed description.

### DETAILED DESCRIPTION OF EXEMPLARY EMBODIMENTS

Reference will now be made in detail to various embodiments which are illustrated in the accompanying drawings, wherein like numerals indicate similar elements throughout the views.

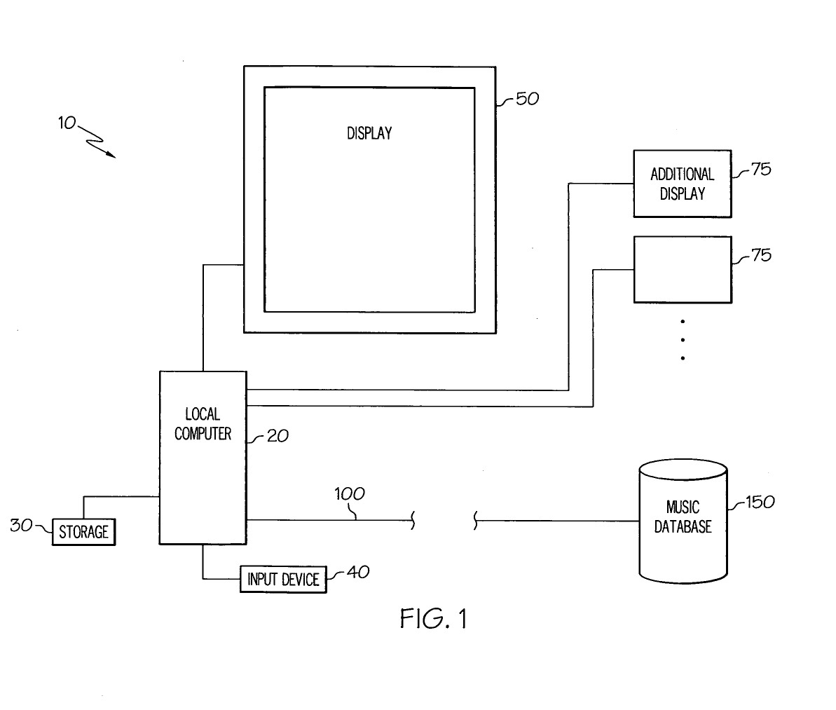

One embodiment of the music management system of the present invention is illustrated in FIG. 1. The music management system 10 comprises a local computer 20, a master display 50, and optionally one or more remote displays 75 in communication with the computer 20. The local computer 20 executes one or more software applications which are capable of establishing a network connection through communication link 100 to remote server or music database 150.

In one exemplary embodiment, the music display system comprises computer hardware and software intended to display digital sheet music on one or more remote displays for a team of musicians or singers to use. In one exemplary embodiment, the hardware comprises a computer 20, a display 50, and one or more input devices 40. In another exemplary embodiment, the display 50 comprises a touch screen LCD or similar touch screen monitor device. The computer 20 is also in communication with a storage device 30. In one embodiment, the storage device is internal to the local computer 20, or in an alternative embodiment, the storage device 30 may be external from the computer 20 and communicate through a communication link.

Another embodiment of the present application is a method for transmitting digital sheet music from a music database 150 to local music management system 10. The method comprises establishing a connection between the music database and the local music management system; sending a retrieval code for a desired digital sheet music to the music database, wherein the retrieval code includes information corresponding to the desired digital sheet music; receiving a digital sheet music data file from the music database in response to the retrieval code; storing the digital sheet music data file in a storage medium, wherein the storage medium is in electronic communication with the local music management system; and displaying the desired sheet on one or more displays in communication with the local music management system. In one exemplary embodiment, the music database comprises an online portal.

In order to minimize potential liability under copyright infringement, in one exemplary embodiment, the music management system utilizes encryption and decryption technology to minimize illegal distribution of the digital sheet music data files between systems. The music management system has the ability to download songs from online content providers. For example, similar to today's MP3 online music purchasing site such as iTunes.com, the user would be able to purchase a digital sheet music data file which could be downloaded and then utilized by the music management system. In one exemplary embodiment the downloaded digital sheet music display file would be in encrypted state. The local music management system would keep the digital music sheet display file in an encrypted state in its local storage system. The song would only be usable by the local music management system provided the correct decryption key is known by the local music management system to open and decode the music sheet data file. In another exemplary embodiment, the encryption key could be based on the membership ID, serial number of the local management system, microprocessor ID of the local music management system, mac address, or a combination of these or any other items having unique value.

In one exemplary embodiment, the connection between the music database and the local music management system is over the Internet. In another embodiment, the digital sheet music data file received from the music database is encrypted. In yet another exemplary embodiment, the local music management system transmits a public encryption key to the music database. In this embodiment, the music database utilizes the public encryption key to encrypt the digital music data file that is then transmitted to the local music management system. The local music management system also has a corresponding private encryption/decryption key which allows it to utilize and process the digital sheet music data file. In one exemplary embodiment, the digital sheet music encryption is common to all users of the local music management system. In other words, only one encryption key is utilized for all music coming into that specific local music management system. In an alternative embodiment, the digital sheet music encryption is unique to each user of the local music management system. In this embodiment, it is viewed that there would be multiple users and/or purchasers of digital sheet music on the system, wherein each user or purchaser would have its own account.

Another embodiment of the present invention comprises storing the digital music data file in a storage device, wherein the method further comprises decrypting the digital sheet music data file before it is stored in the storage medium. As one skilled in the art will appreciate, various decryption/encryption technologies can be utilized and are known to those skilled in the art. In one exemplary embodiment, decrypting the digital sheet music data file comprises utilizing a decryption key corresponding to the public encryption utilized by the music database.

In another exemplary embodiment, the retrieval code includes information corresponding to a user of the local management system and wherein the retrieval code is utilized to generate the encryption key by the music database. In one exemplary embodiment the encryption comprises at least 128 bit encryption.

In another exemplary embodiment of the present invention, the digital sheet music data file includes a digital rights management section, wherein the digital rights management section includes information related to restrictions of the digital sheet music file. For example, exemplary instructions include the ability to print, display, copy or modify the digital sheet music data file. One exemplary embodiment comprises limitations on printing digital sheet music. For example, a user may obtain a license to print a specific number of copies of the digital sheet music for his use. Once those numbers of copies have printed, the user may need to obtain additional license rights to print additional copies of the sheet music. An alternative restriction comprises a limitation on displaying the digital sheet music. In this embodiment, the user may be limited to a number of times the digital sheet music can be displayed or on how many displays simultaneously it can be displayed.

As noted above, any encryption technology known to those skilled in the art may be utilized in the present invention. In one exemplary embodiment, the encryption technology utilizes a serial number of the local music management system. This registered serial number can then be utilized as part of the digital rights management section to allow the digital sheet music data files to be displayed and/or processed by only the licensed local music management system.

In another exemplary embodiment, the encryption algorithm utilizes a number, such as a serial number, obtained from the microprocessor of the local music management system. In this embodiment, if the music database has access to the registered serial number for the local music management system, the music can be encrypted utilizing that serial number to ensure that the digital sheet music data files are only utilized and processed on the licensed and authorized local music management system.

In another exemplary embodiment, the local music management system is configured to display, print and manage the digital sheet music data files while the data files remain encrypted. For example, in this embodiment, the local music management system may decrypt the digital sheet music data file into temporary memory storage such as volatile memory. Such an embodiment minimizes the ability of someone to commit copyright infringement and copy the digital sheet music data files of the local music management system for use on an unauthorized or unlicensed music management system.

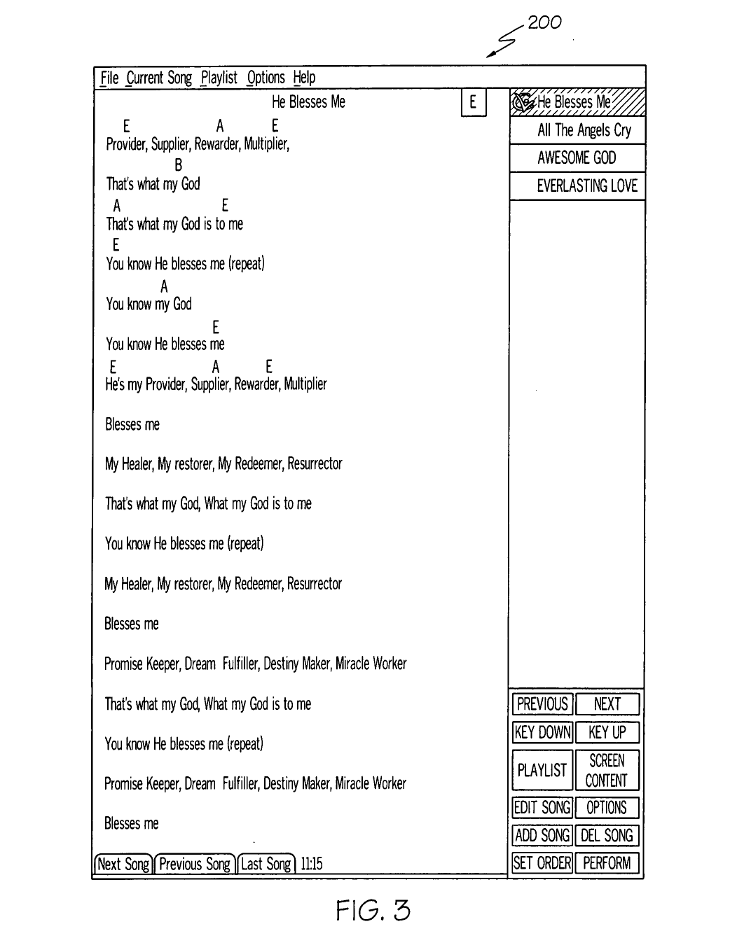

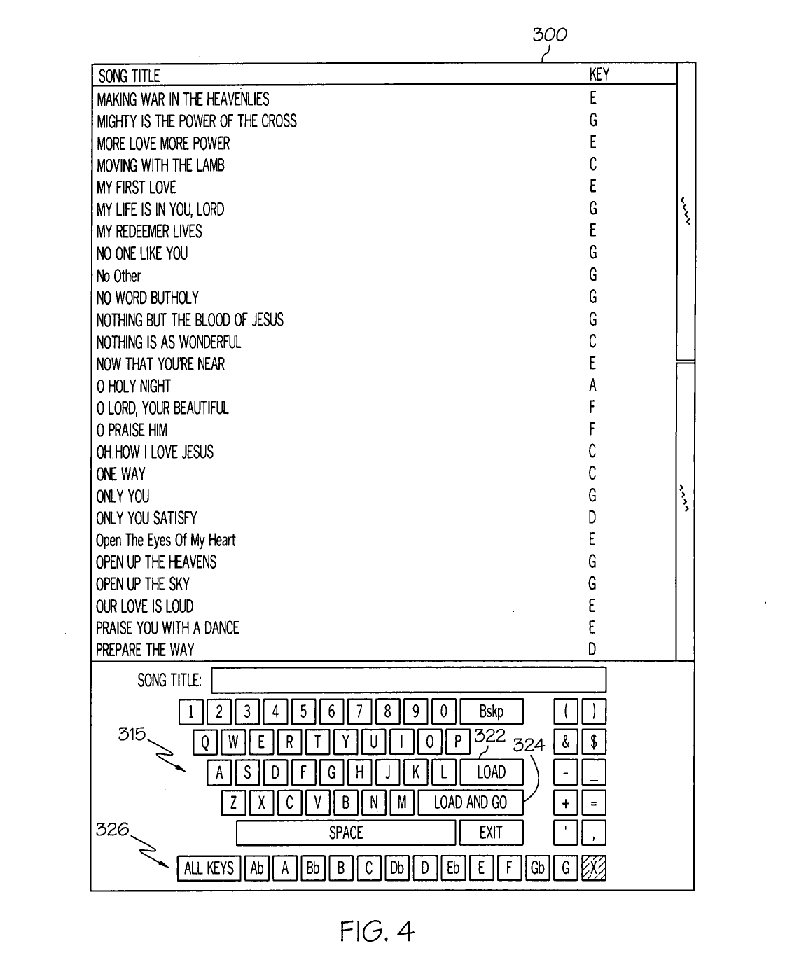

In one exemplary embodiment illustrated in FIG. 3, the local music management system 10 further comprises a graphical user interface 200. The graphical user interface is configured such that the user can visually manage the digital sheet music files 300 stored in the local storage medium as illustrated in FIG. 4. In addition, the graphical user interface can allow the user to browse all the digital sheet music files stored in remote music databases. The exemplary graphical user interface 300 illustrated in FIG. 4, allows a user to search the storage medium/database for digital sheet music data files. For example, using a touch screen, the user can utilize the on-screen keyboard 315. In this exemplary embodiment, once the desired digital sheet music data file is located, the user selects either “LOAD” 322 or “LOAD AND GO” 324. Either LOAD or LOAD AND GO will retrieve the file from the storage medium and load the sheet music into the local music management system. From this point, the user can create playlists, edit the digital sheet music data files, such as change key, transpose for a Capo, or other desired function. The exemplary graphical user interface 300 further is configured to allow a user to search by the key 326 of the music.

As one skilled in the art will appreciate, the digital sheet music data files can comprise one or more various file technologies. For example, exemplary file technologies include RTF, XML, PDF, HTML, or the like.

In one exemplary embodiment, the local music management system comprises one or more input devices. Exemplary input devices include a touch screen, foot pedal, hand wireless remote, keyboard, a mouse and the like. The touch screen is utilized in combination with the graphical user interface to allow a music team leader for song selection, song order, display format and the like. A foot pedal can be programmed for any programmable function. In one exemplary embodiment, the foot pedal is used to advance the display from one digital sheet music file to the next.

As noted above, the local music management system may comprise a graphical user interface. The graphical user interface is configured to allow a user to have access to the stored digital music data files as well as access to external databases and internet music content providers. In an exemplary embodiment, the graphical user interface can be utilized to allow the user to enter a user ID and password and then display a list of available songs for download in any exemplary formats the digital sheet music may be available in.

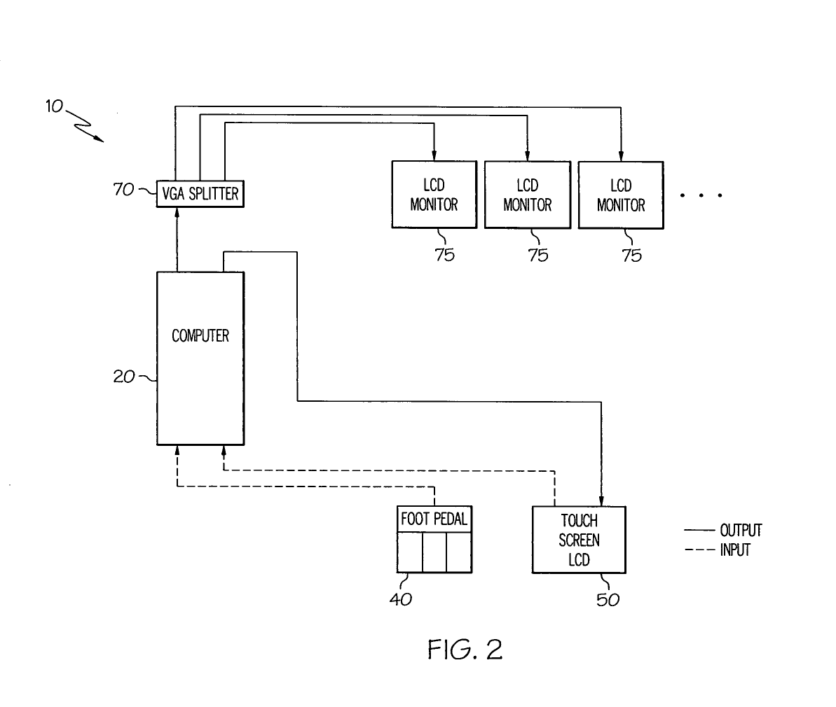

In another embodiment of the present invention, as illustrated in FIG. 2, the local management system 10 comprises a computer 20, a monitor 50 and one or more input devices 40 in communication with the computer. This embodiment further comprises a VGA video signal splitter 70, wherein the video signal output from the computer is split into multiple output streams for the remote displays 75. In this embodiment, the local music management system may not comprise a connection to a remote music server or database. Alternatively, all the digital sheet music data files are stored on the local storage medium. In one exemplary embodiment, the digital sheet music data files are stored on either CD Rom or DVD Rom Discs. These discs can be periodically updated from a digital sheet music publisher and sent to users of the local music management system.

In another exemplary embodiment of the present invention, the local management system comprises a control station and multiple thin client units in communication with the control station. The control station may comprise a personal computer or other networked device in communication with multiple thin client units. A thin client is a network computer typically without a harddisk drive, which, in client/server applications, is designed to be especially small so that the bulk of the data processing occurs on the server. However, in an alternative embodiment, the thin client handles the bulk of the data processing.

In one exemplary embodiment, the local management system comprises a system of networked computing systems, for example a primary personal computer (control station) and one or more multiple thin clients (secondary units), wherein the primary personal computer coordinates music for all of the thin clients.

In one embodiment, the primary unit (control station) networks and links to a group of secondary units. In this embodiment, the primary unit has functionality which includes at least one of the following: the ability to download a list of songs including the song content to one or more secondary units; the ability to select the type/part of music (e/g. trumpet part, piano part, etc.) and send the music content for the selected type for the list of songs to one or more secondary units; the ability to synchronize the list of songs to be displayed on the secondary units; the ability to select the play order of the songs of the playlist in the secondary units; the ability to send commands to select the ‘now playing’ song for the secondary units; the ability to send user defined messages to individual secondary units, groups of secondary units or all of the secondary units; the ability to edit one or more pages of a particular song and send edited page to one or more designated secondary units, such edits include annotations and revised pages, etc.; the ability to receive annotations and other edits from a secondary unit and there store edited/annotated page in database; the ability to synchronize and display a timing devise (e.g. metronome) or sound an audio output on each or selected ones of the secondary units, as well as the ability to maintain such synchronization.

In another embodiment, the secondary units have one or more of the following functionality; the ability to operate in a networked environment or in a “stand-alone” mode; the ability to allow a user to annotate/edit/mark-up pages of music using a user input interface such as a keyboard and mouse device; the ability to allow the user to change the song or displayed page using an input device; the ability to change the song or displayed page on other secondary units displaying the same content as primary unit; and the ability to send user defined messages to the control station and/or other secondary units.

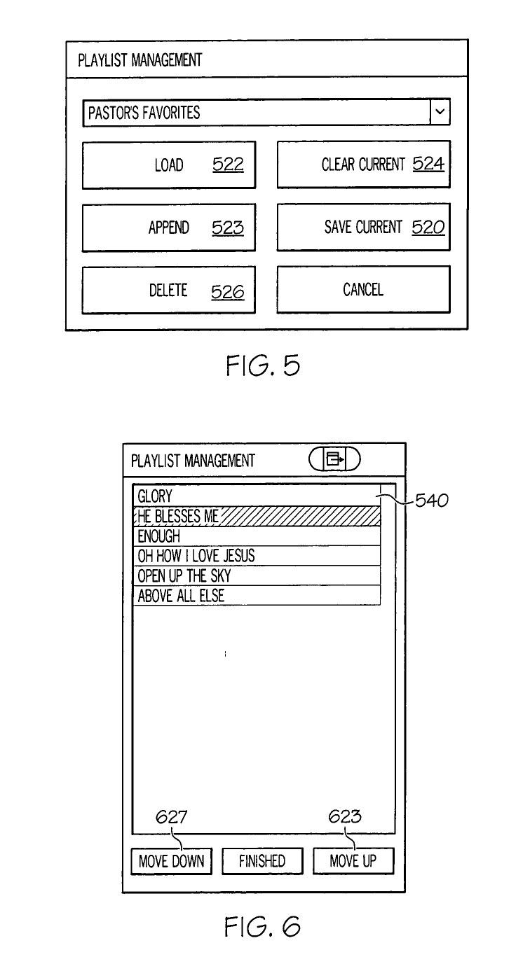

In one exemplary embodiment, the local music management system comprises the ability to create playlists, wherein the playlist comprises a listing of stored digital sheet music data files to be displayed in a specific order and timing. As one skilled in the art will appreciate, the playlists is similar to a music playlist such as a MP3 player playlist in that it allows the user to pre-select the digital sheet music to be displayed in a specific order and then to store 520 and later manage that playlist as illustrated in FIG. 5. In one exemplary embodiment, the user can select to load 522 one of the previously created playlists. In addition, the user may append 523 a playlist with one or more digital sheet music data files or another stored playlist. Other exemplary functions of the playlist management graphical user interface comprise clearing 524 the current playlist and the ability to delete 526 playlists.

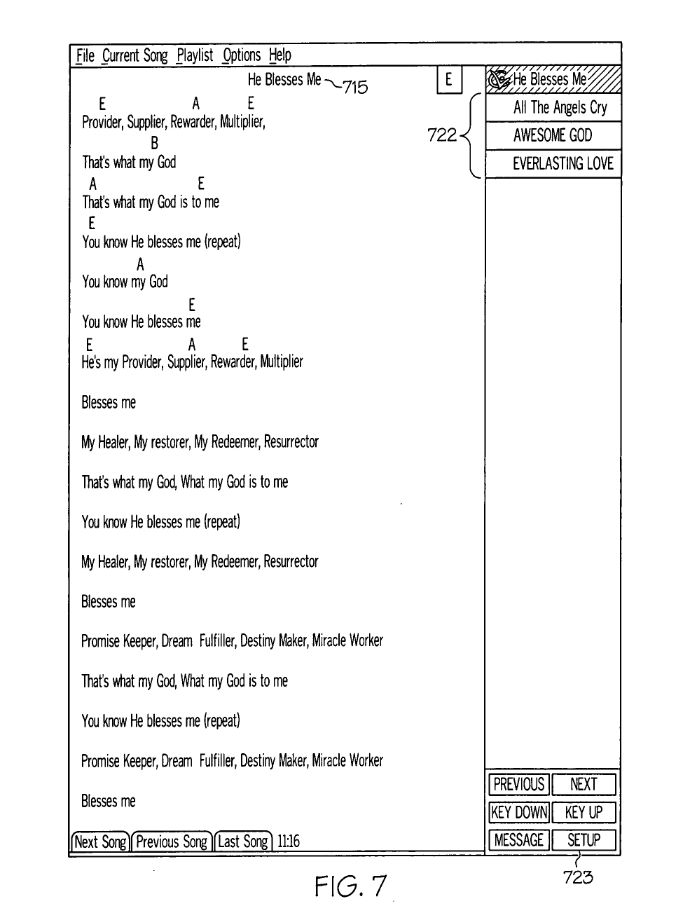

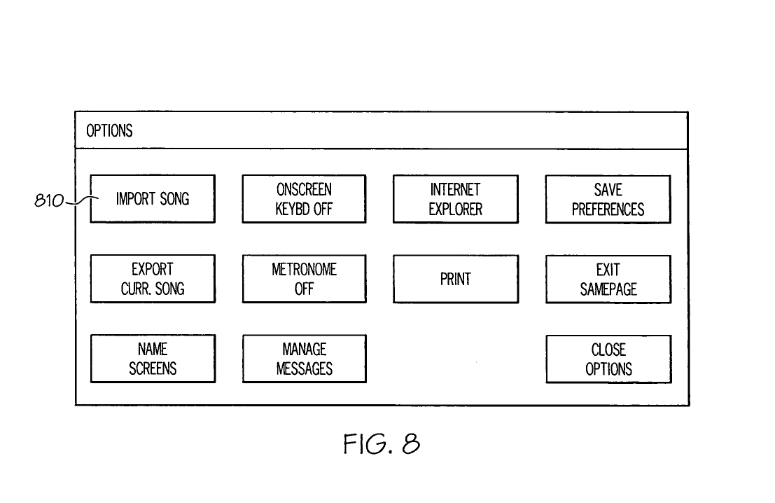

In another exemplary embodiment of the present invention as illustrated in FIG. 6, the playlists can be altered instantaneously. In this exemplary embodiment, the user can reorder the playlist 540 by moving any of the songs up 623 or down 627 in the playlist order. Moreover, as illustrated in FIG. 7, the playlist can be altered while even playing and displaying another song's sheet music digital file 715. The user or conductor has the ability to change to a set-up mode 723 on a portion or all of his display and alter the playlist 722 by selecting additional songs to be added or deletion of songs and even the ability in one exemplary embodiment to download from remote music databases additional songs.

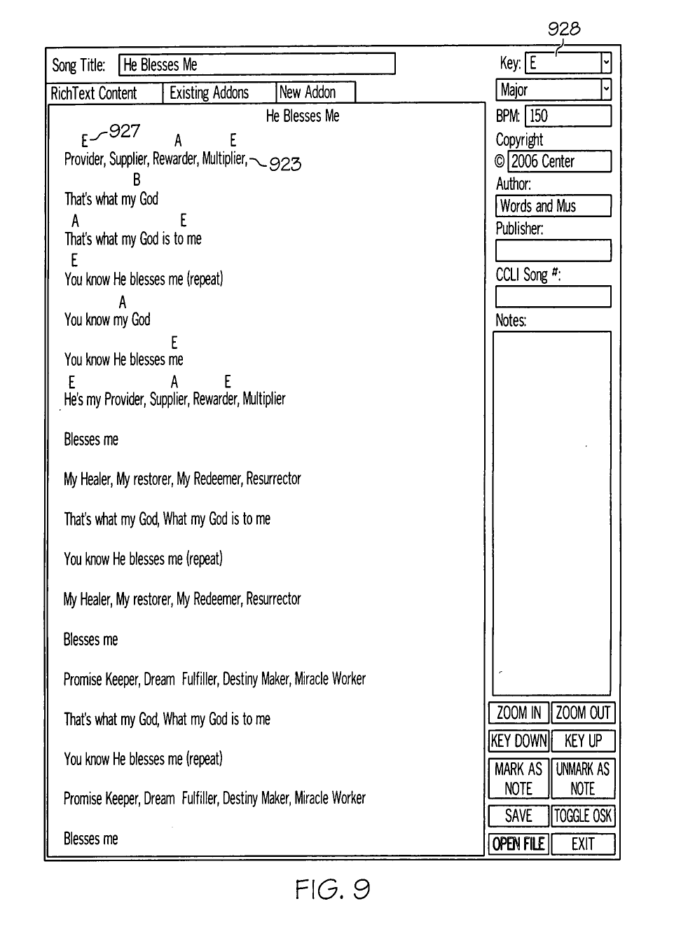

In another embodiment of the invention as illustrated in FIG. 8, the local music management system has the ability to import song files 810 and to create digital sheet music files from them. In one exemplary embodiment, conventional sheet music can be scanned and run through a set of algorithms of the local music management system to convert the scanned sheet music to a digital sheet music format. The digital sheet music format may then be either stored in a text display mode or in typical music scroll display mode and saved in any format such as music XML, etc. The local music management system has the ability to download digital sheet music files through various technologies known to one skilled in the art such as peer to peer technologies such as bit-torrent, over the internet, or using removable computer storage mediums containing one or more digital sheet music files.

In one embodiment of the present invention, the digital sheet music file created by importing a song file from the local music management system will be encrypted only on the local music management system. In an alternative embodiment, multiple local music management systems may be connected through a network system, such as over the internet, and be able to utilize their music databases with each other's systems. Moreover, there is a large collection of public domain sheet music available in print and digital form on the internet. Since these sheet music files are not subject to copyright restrictions, multiple local music systems could use and network these without any copyright infringement considerations.

In another exemplary embodiment, the local music management system comprises a licensing rights enforcement system. The licensing rights enforcement system monitors the digital rights management restrictions for each file, and if the user desires to either print or display a particular file in excess of its current licensed value, the local music management system, in one exemplary embodiment, will automatically obtain an additional license value at a preset royalty amount. In one exemplary embodiment, this royalty is paid immediately and an additional license obtained through the remote database, wherein in an alternative embodiment, the local music management system will periodically, such as weekly or monthly, contacts the remote music management database system to make royalty payments and balance the number of licenses.

In one exemplary embodiment, as illustrated in FIG. 9, a user can modify content of the music sheet data file. For example, the user can change lyrics 923 on the song, change music notes or chords 927 to be played, or even change the key 928 of the song. Corresponding algorithms in the music management system are then executed and generate the desired output.

In another exemplary embodiment, the local music management system stores the digital sheet music data files on an external storage medium, such as on the internet. In this embodiment, the digital sheet music data files can be accessed via an internet connection. In one exemplary embodiment, the external storage medium comprises a third-party hosted web environment, server form or digital storage facility.

In yet another embodiment, the local music management system comprises a web-based hosted application. In this embodiment, the local music management application is hosted on a remote web server and generates various web pages to manage the local music management system.

The foregoing description of the various embodiments and principles of the invention has been presented for the purposes of illustration and description. It is not intended to be exhaustive or to limit the invention to the precise forms disclosed. Many alternatives, modifications, and variations will be apparent to those skilled in the art. For example, some of the principles of this invention may be utilized in other music management systems. Moreover, although multiple inventive concepts have been presented, such aspects need not be utilized in combination, in various combinations of the inventive aspects are possible in light of the various embodiments provided above. Accordingly, the above description is intended to embrace all possible alternatives, modifications, combinations, and variations that have been discussed or suggested herein, as well as all others that fall within the principles, spirit, and broad scope of the invention as defined by the claims.

What is claimed is:

1. A method for transmitting digital sheet music from a music database to a local music management system, comprising:
establishing a connection between the music database and the local music management system, wherein the local music management system comprises a primary station and one or more remote displays;
sending a retrieval code for a desired digital sheet music to the music database, wherein the retrieval code includes information corresponding to the desired digital sheet music;
receiving a digital sheet music data file from the music database in response to the retrieval code, wherein the digital sheet music data file comprises one or more instrument sheet music parts and/or one or more chord sheet music parts;
transmitting the instrument sheet music parts to one or more corresponding remote displays in communication with the local music management system.

2. The method of claim 1, wherein the instrument sheet music parts are transmitted instantaneously to the one or more corresponding displays.

3. The method of claim 1, further comprising: storing the digital sheet music data file in a storage medium, wherein the storage medium is in electronic communication with the local music management system.

4. The method of claim 1, wherein the digital sheet music data file is encrypted.

5. The method of claim 4, wherein the digital sheet music encryption is common to all users of the local music management system.

6. The method of claim 4, wherein the digital sheet music encryption is unique to each user of the local music management system.

7. The method of claim 4, wherein the retrieval code includes information corresponding to a user of the local music management system, and wherein the retrieval code is utilized to generate an encryption key.

8. The method of claim 1, wherein the retrieval code includes information corresponding to the one or more remote displays in communication with the local music management system.

9. A method for creating a playlist of one or more digital sheet music data files, comprising:
determining a list of digital sheet music data files stored on a storage medium, wherein each of the digital sheet music files comprises one or more instrument sheet music parts;
displaying the list of digital sheet music data files through a graphical user interface;
receiving a user's selection of one or more digital sheet music data files from the playlist;
determining an instrument part for any connected remote displays;
transmitting the corresponding instrument sheet music parts to the connected remote displays.

10. The method of claim 9, further comprising:
receiving a user's selection through the graphical user interface to revise the playlist;
after receiving a user's input corresponding to end of revisions, transmitting the playlist to the remote displays.

11. The method of claim 9, wherein the playlist further comprises sermon notes, notes, lyrics only for display devices, scripture readings, images and/or a combination of such.

12. The method of claim 11, further comprising:
transmitting the playlist to one or more additional display devices.

13. The method of claim 13, wherein the additional display devices comprise a projection display device.

14. A local music management system for displaying digital sheet music, comprising:
a computer having a processor and computer readable memory;
a main display unit;
one or more remote displays, wherein the one or more remote displays are in communication with the computer, and wherein the computer is adapted to send one or more data signals to the remote displays; and
wherein the computer readable memory comprises a set of instructions for execution by the processor; and wherein the set of instructions comprises:
providing a graphical user interface, wherein the graphical user interface is configured to allow a user to retrieve digital sheet music from a music database, and wherein the digital sheet music comprises one or more instrument sheet music parts;
determining which remote displays are in communication with the computer and determining the appropriate instrument part to be displayed on each of the remote displays;
in response to a user request on the graphical user interface, retrieving a desired digital sheet music from the music database and instantaneously transmitting the corresponding instrument sheet music parts to the determined instrument parts of the remote displays.

15. The system of claim 14, wherein the one or more remote displays comprise an addressable computing device.

16. The system of claim 15, wherein the addressable computing device comprises a thin client.

17. The system of claim 14, wherein the instrument sheet music parts comprises lyrics only, and the determined instrument parts of the remote displays comprises a projection display system.

18. The method of claim 4, wherein the digital sheet music encryption is common to multiple displays of the local music management system.
